(19) United States
(12) Patent Application Publication
(10) Pub. No.: US 2024/0261066 A1
(43) Pub. Date: Aug. 8, 2024

(54) DENTAL IMPLANT AND POST SYSTEM WITH REVERSE THREADED IMPLANT

(71) Applicant: Dan ROSEN, Sherman Oaks, CA (US)

(72) Inventor: Dan ROSEN, Sherman Oaks, CA (US)

(21) Appl. No.: 18/105,794

(22) Filed: Feb. 3, 2023

(51) Int. Cl. A61C 8/00

(52) U.S. Cl. CPC A61C 8/0022; A61C 8/0069; A61C 8/0089

(57) ABSTRACT

A dental implant and post apparatus having a reverse threaded dental implant is used for mounting on a dental drill having a direction of rotation opposite the advancing direction of the helical threads of the dental implant, for installation in patient bone. The apparatus includes a dental implant having a head portion with a bore and a threaded portion, and a post (also known as an abutment) having a post stem, a lower conical portion, and an upper conical portion. The bore includes a post stem receiving portion for receiving the post stem, and a conical sidewall configured to engage the lower conical portion. The threaded portion comprises threads oriented in a direction opposite the direction of rotation of the dental drill to drive the implant in an unscrewing rotation when spun by the dental drill, thereby causing the threads to force the bone down, out, and away from the implant as it is inserted into the patient.

### FIELD OF THE INVENTION

The present invention generally relates to dental implants. More specifically the invention relates to a dental implant and post apparatus for installation in an osteotomy. More specifically, the invention relates to a specialized dental implant facilitating successful osseointegration between the dental implant and the patient's bone for installing a post and dental prosthetic thereon.

### RELATED ART

Restorative dental implants and prosthetics are known for replacing individual teeth. Single tooth restorations involve installing freestanding units not connected to other teeth or implants in replacing missing individual teeth. For individual tooth replacement, a post (also known as an implant “abutment” is secured to the dental implant with an abutment screw. A dental prosthesis (also known as a “crown”) is then affixed to the abutment with dental cement, a small screw, or fused with the abutment as one piece during fabrication.

Due to the individual nature of these implants, in which a single dental implant is responsible for entirely supporting the dental prosthetic and resisting the entirety of stress forces against the prosthetic, fixation of the implant in the patient's bone is of paramount importance. Dental implants to which abutments are affixed are in the form essentially of a screw, having a head portion in which the abutment is seated, and a threaded portion which engages a patient's bone. An osteotomy is first prepared by drilling into the patient's bone. The threaded portion of the dental implant then screws into the bone in a manner like a conventional screw. The dental implant must set, through osseointegration, in the patient's bone before a post (abutment) can be installed thereon, and a dental prosthetic installed on the post.

Since osseointegration is of the primary goal when installing a dental implant, the conditions under which the implant is installed are important. The bone surrounding an osteotomy into which a dental implant is inserted is soft and prone to compression, dislodging, and other damage. For this reason, a dental implant must be carefully screwed into position. When a conventionally threaded dental implant is screwed into position, the advancing helical structure of the threads tends to draw bone outward toward the opening of the osteotomy. This is disfavored because it negatively impacts osseointegration.

Hence, what is needed is a dental implant and post system wherein the dental implant has improved characteristics to avoid negatively impacting an implant site. More specifically a dental implant is needed having a threaded portion wherein the threads avoid damage to the implant site. This is accomplished by providing a dental implant having a reverse threaded pattern as described more fully herein, which helps to avoid extracting boned from an implant site when the dental implant is installed.

### SUMMARY

A dental implant and post (also known as an “abutment”) apparatus is provided with reverse threads on the implant. The implant is configured for mounting on a dental drill for installing the implant in patient bone, the dental drill having a direction of rotation. In particular, the apparatus comprises a dental implant having a head portion with a bore and a threaded portion. A post is associated with the dental implant, for insertion therein. The post includes a post stem, a lower conical portion, and an upper conical portion. The bore of the dental implant includes a post stem receiving portion for receiving the post stem, and has a conical sidewall configured to engage the lower conical portion of the post.

The threaded portion of the dental implant has threads around its circumference like a conventional dental implant. Unlike a conventional dental implant, the threads are oriented in a direction opposite the direction of rotation of the dental drill. This means that the dental drill, when rotating, drives the dental implant threads in an unscrewing rotation, thereby causing the threads to force material down, out, and away from the implant as it is inserted into an osteotomy of the patient, and encounters the patient bone.

The threaded portion is preferably tapered inward toward a tip of the dental implant located opposite the post. The tip of the dental implant is inserted into the patient's osteotomy followed by the remainder of the threaded portion of the dental implant, which is broader in circumference than the tip. The threads of the threaded portion include a pronounced edge, which may present a cutting edge extending from the threaded portion. The pronounced edge is preferably greater in profile toward the tip of the dental implant opposite the post, and lesser in profile farther up the dental implant as the threads travel away from the tip.

The head portion further comprises a collar portion between the post and the threaded portion. The post stem receiving portion in the dental implant and the post stem of the post are complimentarily threaded, such that the post stem receiving portion and post stem anchor the post against the implant when installed therein. The conical sidewall of the post stem receiving portion is preferably configured to engage the entirety of the surface of the lower conical portion of the post for a resilient anchorage in the dental implant.

The post preferably includes at least one flat face on the upper conical portion, which is otherwise cylindrical. The flat face (or faces) help anchor a prosthetic atop the post, serve as an anchorage for a cementing agent and prevent the prosthetic from rotating relative to the post and dental implant when installed thereon. In one alternative embodiment, the head portion may extend circumferentially outward beyond a circumferential extent of the threaded portion. In another alternative embodiment, the bore may extend into the threaded portion to increase resiliency of the post's connection to the dental implant.

A method of installing a dental implant and post apparatus with a reverse threaded dental implant is also disclosed. The method is provided for mounting the dental implant and post apparatus with a reverse threaded dental implant on a dental drill for installation in a patient osteotomy, without unduly removing material from within the osteotomy. The method includes at least the steps of 1) providing a dental implant with a head portion, a bore and a threaded portion, 2) providing a post having a post stem, a lower conical portion, and an upper conical portion, 3) mounting the implant portion on the dental drill, 4) inserting the implant portion into the osteotomy while rotating the implant such that the threaded portion rotates in a way that drives material it encounters further into the osteotomy, and 5) once the implant is securely in place, mounting the post on the dental drill and installing the post in the dental implant. All the above embodiments of the dental implant and post apparatus are contemplated in execution of the method.

### BRIEF DESCRIPTION OF THE FIGURES

FIG. 1 illustrates an elevation view of a dental implant and post system wherein the dental implant is reverse threaded relative to the turn direction of a driver, according to the present disclosure.

FIG. 2 illustrates a top plan view of the dental implant and post system according to the present disclosure.

FIG. 3 illustrates a bottom plan view of the dental implant and post system according to the present invention.

FIG. 4 is an exploded view of the dental implant and post system according to the present invention, with the dental implant post receiving bore shown in cut-away view.

FIG. 5 is a cut-away view of a patient's jaw showing the dental implant and post system installed I the patient's bone, and an osteotomy for receiving the dental implant and post system.

### REFERENCE NUMBERS

10. dental implant and post system
12. threads
14. pronounced edge
16. axis
18. threaded portion
20. head portion
22. collar portion
24. secondary threads
26. terminal thread portion
28. tip
30. out-slanted portion
32. head portion
34. flat face
36. implant portion
38. post stem receiving portion
40. cylindrical profile
42. conical sidewall
44. conical threaded bore
46. opening
48. lower conical portion
50. upper conical portion
52. post portion
54. post stem

### DESCRIPTION

The following description is presented to enable any person skilled in the art to make and use the apparatus disclosed herein and is provided in the context of a particular application and its requirements. Various modifications to the disclosed implementation will be readily apparent to those skilled in the art, and the general principles defined herein may be applied to other implementations and applications without departing from the spirit and scope of the present disclosure. Importantly, the size or configuration of the components discussed herein may be modified from the way they are depicted and described herein without departing form the spirit and scope of the claimed implementation. Thus, the present disclosure is not limited to the implementation shown but is to be accorded the widest scope consistent with the principles and features disclosed herein.

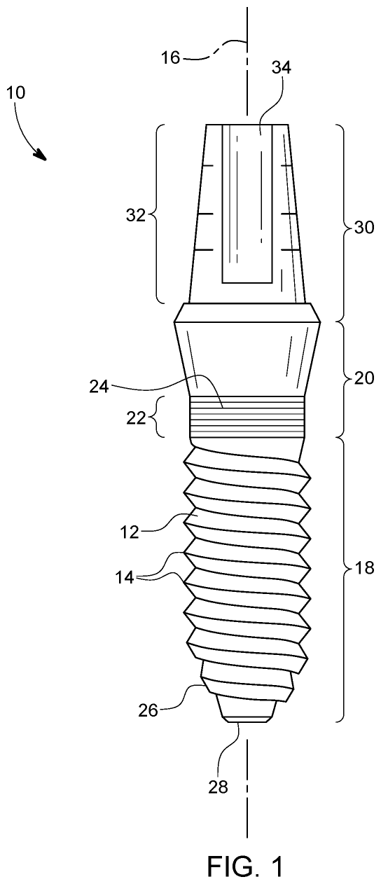

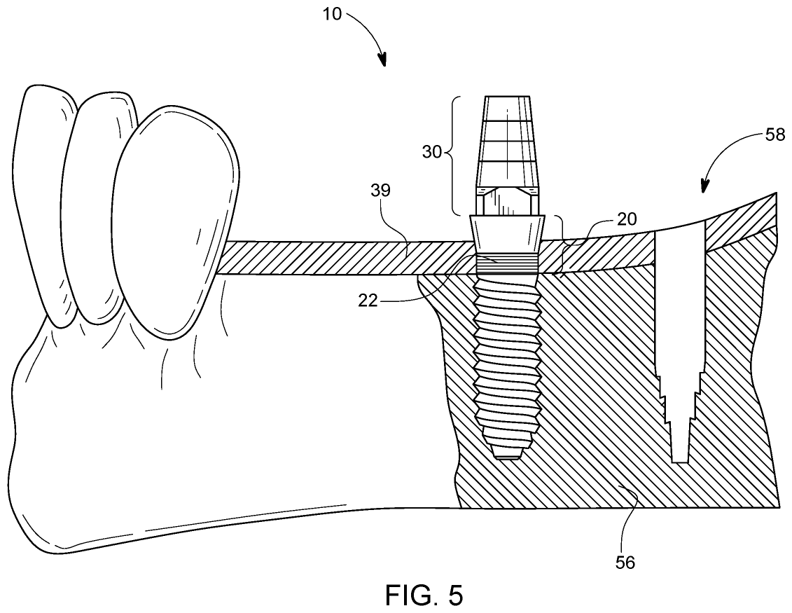

Referring to FIG. 1, a dental implant and post system 10 according to one implementation is shown in elevation view view. The dental implant and post system 10 includes an implant threaded portion 18 and an implant head portion 20. The implant threaded portion 18 has threads 12 having a pronounced edge 14. The threads 12 are oriented around a vertical axis 16 of the dental implant and post system 10. Importantly, the threads 12 are oriented against the direction of rotation of a dental drill (not shown) used to drive the dental implant into a patient's bone (FIG. 5, ref. no. 56).

Still referring to FIG. 1 the implant head portion 20 of the implant and post system 10 includes a collar 22 which may have secondary threads 24 or a similar minor surface feature adapted to engage the patient's bone 56. The collar 22 and head portion 20 are adapted to engage at the interface between the patient's bone 56 and the gums surrounding the patients' teeth (FIG. 5). The threaded portion 18 is designed to have a terminal thread portion 26 sloping inward toward the axis 16 at a tip 28 of the threaded portion 18 where it is inserted into a patient's osteotomy (FIG. 5, ref. no. 58).

Still referring to FIG. 1, the head portion 32 of the implant and post system 10 seats in the implant (18/20) to form an out-slanted portion 30, on which a prosthetic tooth (not shown) will be seated. In one implantation, the head portion 32 may include one or more flat faces 34 to help prevent a prosthetic tooth from rotating relative to the head portion.

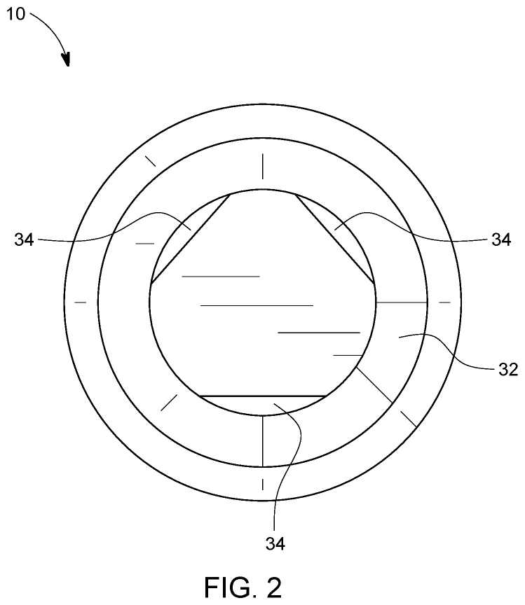

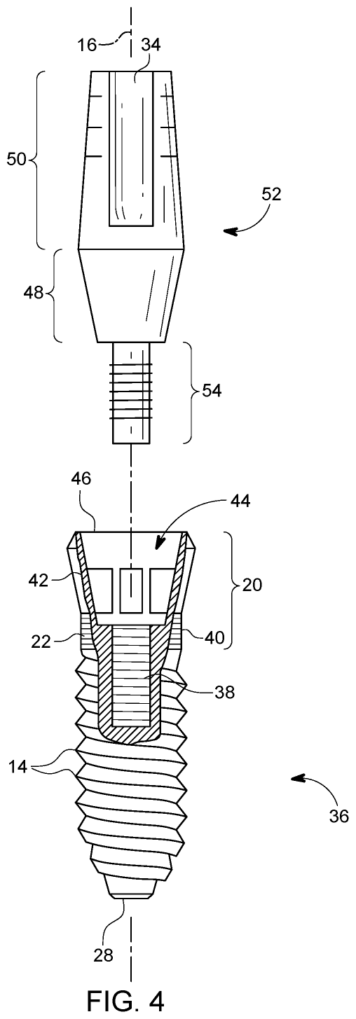

Referring to FIG. 2, the implant and post system 10 is shown in top plan view. The head portion 32 of the post (FIG. 4, ref. no. 52) is shown with the flat faces, and surrounding the head portion 32 of the post 52 is surrounded by the implant portion of the implant and post system 10, ready for a prosthetic tooth to be affixed thereto.

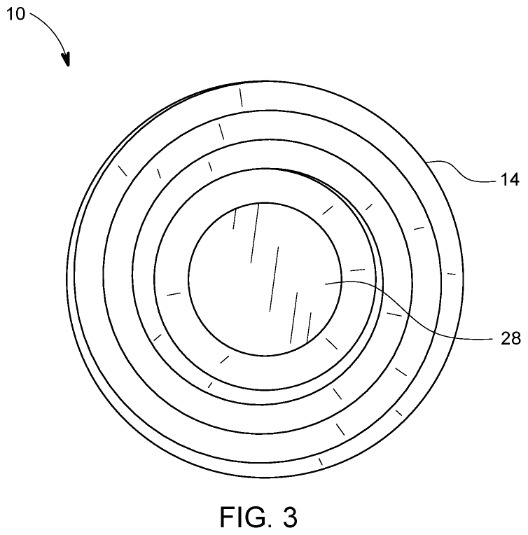

Referring to FIG. 3, the implant and post system 10 is shown in bottom plan view. This view shows the pronounced edge 14 of the threads 12 (FIG. 1) as they extend from the tip 28 of the threaded portion 18 (FIG. 1) of the implant. The threads 12 are configured in a reverse orientation to the drive direction of the dental drill (not shown). For example, in the illustrated view, a dental drill would have a clockwise spin, whereas the threads 12 have a counterclockwise orientation. When the dental implant is mounted to the dental drill and the dental drill activated, the implant spins in a direction wherein the threads are pushing bone encountered by the pronounced edge 14 downward and outward. This differs from the extractive action of an engaging thread pattern (as would be the case if, the illustrated view, the dental drill had a counterclockwise spin).

Referring to FIG. 4, the dental implant and post system 10 is shown in exploded view. As shown in this view the implant portion 36 includes a conical threaded bore 44 extending inward from the head portion 20 of the implant portion 36. Although the head portion 20 is primarily conical, in one embodiment, the collar portion 22 presents a cylindrical profile 40 to conserve material and strengthen the implant portion 36 where material is removed for forming the conical threaded bore 44. The conical threaded bore 44 includes an opening 46 into which the post portion 52 seats.

Still referring to FIG. 4, a post stem receiving portion 38 of the conical threaded bore 44 is configured to receive the post stem 54 of the post portion 52. The post stem 54 and the post stem receiving portion 38 preferably have complimentary threads for securely anchoring the post portion 52 into the implant portion 36. The conical threaded bore 44 also preferably includes a conical sidewall 42 which is complimentary to the lower conical portion 48 of the post portion 52. Although a conical threaded bore 44 is shown in the illustrated view, in various alternative embodiments, the connection of the post to the implant may employ a pattern to prevent rotation of the post relative to the implant. This may include an internal hex pattern, an external hex pattern a tri-lobe connection, or any other non-circular pattern. When the post stem 54 is inserted through the opening 46 into the conical threaded bore 44, lowered into the post stem receiving portion 38 and secured therein by tightening, the lower conical portion 48 of the post portion 52 comes into full contact with the conical sidewall 42 of the implant portion 36, securely fastening it therein.

Once the post portion 52 is completely secured in the implant portion 36, the upper conical portion 50 is exposed above the patient's gum line for installation of a prosthetic tooth thereon. The prosthetic tooth engages the upper conical portion 50, and may abut the head portion of the implant portion 36, and the flat faces 34 present on the upper conical portion 50 help anchor the prosthetic tooth in position.

The foregoing descriptions of implementations of the present disclosure have been presented only for purposes of illustration and description. They are not intended to be exhaustive or to limit the present disclosure to the forms disclosed. Accordingly, many modifications and variations will be apparent to practitioners skilled in the art. Additionally, the above disclosure is not intended to limit the present implementations disclosed herein. The scope of the present disclosure is defined by the appended claims.

Although one or more very narrow claims may be presented herein, it should be recognized the scope of this disclosure is much broader than presented by the claims. It is intended that broader claims may be submitted, if appropriate, that claim the benefit of priority from this application.

What is claimed is:

1. A dental implant and post apparatus with reverse threaded implant for mounting on a dental drill having a direction of rotation for installation in patient bone, the apparatus comprising:
a dental implant having a head portion with a bore and a threaded portion;
a post having a post stem, a lower conical portion, and an upper conical portion;
wherein the bore includes a post stem receiving portion for receiving the post stem, and a conical sidewall configured to engage the lower conical portion;
wherein the threaded portion comprises threads oriented in a direction opposite the direction of rotation of the dental drill, to drive the implant in an unscrewing rotation when spun by the dental drill, thereby causing the threads to force the bone down, out, and away from the implant as it is inserted into the patient.

2. The apparatus of claim 1 wherein the threaded portion is tapered toward a tip of the dental implant opposite the post.

3. The apparatus of claim 1 wherein the threaded portion has threads with a pronounced edge extending from the threaded portion.

4. The apparatus of claim 3 wherein the pronounced edge is greater in profile toward a tip of the dental implant opposite the post.

5. The apparatus of claim 1 wherein the head portion further comprises a collar portion between the post and the threaded portion.

6. The apparatus of claim 1 wherein the post stem receiving portion and the post stem are complimentarily threaded, such that the post stem receiving portion and post stem anchor the post against the implant.

7. The apparatus of claim 1 wherein the conical sidewall is configured to engage the entirety of the surface of the lower conical portion.

8. The apparatus of claim 1 wherein the post comprises at least one flat face on the upper conical portion.

9. The apparatus of claim 1 wherein the head portion extends circumferentially outward beyond a circumferential extent of the threaded portion.

10. The apparatus of claim 1 wherein the bore extends into the threaded portion.

11. A method of installing a dental implant and post apparatus with reverse threaded implant for mounting on a dental drill for installation in a patient osteotomy, the method comprising the steps of:
providing a dental implant with a head portion, a bore and a threaded portion;
providing a post having a post stem, a lower conical portion, and an upper conical portion;
mounting the implant portion on the dental drill;
inserting the implant portion into the osteotomy while rotating the implant such that the threaded portion rotates in a way that drives material it encounters further into the osteotomy;
once the implant is securely in place, mounting the post on the dental drill; and
installing the post in the dental implant.

12. The method of claim 11, wherein the threaded portion is tapered a tip of the dental implant, which is inserted into the osteotomy.

13. The method of claim 11 wherein the threaded portion has threads with a pronounced edge extending from the threaded portion, and engaging walls of the osteotomy with the pronounced edge.

14. The method of claim 13 wherein the pronounced edge is greater in profile toward a tip of the dental implant opposite the post.

15. The method of claim 11 wherein the head portion comprises a collar portion between the post and the threaded portion.

16. the method of claim 11 wherein the post stem and the bore are complimentarily threaded, such that the bore and post stem anchor the post against the implant.

17. The method of claim 11 further comprising the step of engaging the lower conical portion to a conical sidewall of the implant.

18. The method of claim 11 wherein the post comprises at least one flat face on the upper conical portion.

19. The method of claim 11 wherein the head portion extends circumferentially outward beyond a circumferential extent of the threaded portion.

20. The method of claim 11 wherein the bore extends into the threaded portion.
